(19) United States
(12) Patent Application Publication
(10) Pub. No.: US 2010/0256843 A1
(43) Pub. Date: Oct. 7, 2010

(54) System for Vital Brake Interface with Real-Time Integrity Monitoring

(75) Inventors: Harvey Bergstein, North Bellmore, NY (US); Thomas R. Metzger, Wheatfield, NY (US); Michael R. Pawlak, Lewiston, NY (US); Warren H. Klinck, JR., Merrick, NY (US)

Correspondence Address: Lockheed Martin c/o;DEMONT & BREYER, LLC, 100 COMMONS WAY, Ste. 250, HOLMDEL, NJ, 07733, US

(73) Assignee: Lookheed Martin Corporation, Bethesda, MD (US)

(21) Appl. No.: 12/753,534

(22) Filed: Apr. 2, 2010

Related U.S. Application Data
(60) Provisional application No. 61/166,163, filed on Apr. 2, 2009.

(51) Int. Cl. B61L 99/00; G06F 19/00; B60T 17/18; B60T 17/22

(52) U.S. Cl. 701/19

(57) ABSTRACT

A train control system comprising a vital brake interface unit that is disposed between the train control processors and the braking system. The brake interface unit ensures that any failure in the control processors or the interface itself is detectable and, when detected, causes the system to fail safely (i.e., the train's brakes are applied). By virtue of the use of redundant circuitry paths, the vital braking interface unit enables real-time verification of system circuitry without actually applying the train's brakes.

### CROSS-REFERENCE TO RELATED APPLICATIONS

This application claims the benefit of U.S. provisional application Ser. No. 61/166,163, filed Apr. 2, 2009, entitled System for Vital Brake Interface with Real-Time Integrity Monitoring (Attorney Docket 711-264us), which is also incorporated by reference.

### FIELD OF THE INVENTION

The present invention relates to railroads in general, and, more particularly, to railroad braking systems.

### BACKGROUND OF THE INVENTION

In the early days of railroads, train brakes were operated by brakemen who would manually activate and deactivate the brakes on the train. This added to the expense of operating the train and ultimately led to the development of air brakes.

In an air brake system, pressurized air is distributed via an air brake pipe system to each brake cylinder on a train. The brake calipers are designed so that the brake shoes engage the train wheel to stop the train if the pressurized air flow is disrupted. These systems typically include what is referred to as a “P2A” valve, which is used for a “penalty” braking. Penalty braking, which is distinct from emergency braking, is the activation of the train's brakes to stop the train when the train is operating, or about to be operated, in an unsafe manner. A penalty brake application “penalizes” a train engineer for operating the train in such a manner.

The typical P2A valve is connected to the brake pipe and typically provides for a full service application of the brakes at the service rate when opened. The P2A valve is electrically controlled, usually employing a solenoid. This allows the P2A valve to be controlled by an over-speed signal from a speed indicator connected to the train's axle drive tachometer, by a penalty brake signal from a cab signal system, or by an alerter. These air brake systems that include a P2A valve are failsafe or “vital” (i.e., safety critical) in that any loss of air pressure in the brake lines or any disruption in power to the P2A valve results in brake activation and the train being brought to a stop safely.

More recently, electronic braking systems have appeared. These systems electronically control the application of the brakes. These systems are required to be failsafe; that is, loss of power to the electronic braking system must result in the train brakes activating to stop the train.

In addition to electronic braking systems, train control systems are also known in the art. Train control systems are systems that control the movement of a train by controlling the locomotive's engine/motor and brakes to ensure that the train is operated safely. These systems can be either “active” or “passive.” In active systems, the system itself is primarily responsible for controlling movement of the train. In passive control systems, a human operator is primarily responsible for controlling movement of the train. The passive control system only assumes control if the operator attempts to operate the train in an unsafe manner, such as by exceeding a maximum allowable speed, entering an occupied block, etc. Exemplary train control systems include “Cab Signal,” “Positive Train Control,” and “Positive Train Stop.”

In order for a train control system of any type to be capable of stopping a train, it must be capable of controlling the train's braking system. These electronic braking systems are typically integrated, sealed units that are not readily modified. As a consequence, it has typically been necessary to enlist the assistance of the manufacturer of the electronic braking system to modify the electronic braking system to permit a penalty application of the brakes by a train control system. Actions/inaction that might give rise to a penalty brake application include, for example, failing to periodically give an indication of alertness, operating or operating the train in excess of a safe limit.

Typical electronic braking systems provide an interface (e.g., RS-232, etc.) through which a train control system can send a request to activate the brakes. But as presently implemented, these systems are not failsafe. For example, if the connection between the train control system and the interface is broken, or the interface on the electronic braking system fails, a brake activation request message from the train control system to the electronic braking system will not be received by the electronic braking system. The brakes will not, therefore, activate. This can lead to a potentially dangerous situation.

### SUMMARY OF THE INVENTION

The present invention provides a train control system with automatic train protection functionality that is capable of stopping the train safely through the use of a vital braking system. This protection functionality would activate, for example, when speed limits or movement authorities are violated.

In accordance with the illustrative embodiment, a vital command interface or “brake interface unit” is disposed between the train control processors and the braking system. This vital braking interface enables real-time verification without actually applying the train's brakes. The brake interface unit ensures that any failure in the control processors or interface is detectable and the system will fail safely.

In accordance with the illustrative embodiment, the train's brakes are maintained in a “released” (i.e., not applied) state only when a single AC signal that is generated by two control processors is received. If the AC signal is not received, or a component fails, the brakes will be applied. In some embodiments, the brake interface unit uses only passive discrete components and is both optically and inductively isolated from the actual brake circuit.

The brake interface unit comprises four circuits. In the illustrative embodiment, those circuits control four solid-state relays. The relays are optically isolated from the penalty brake circuit. In the illustrative embodiment, the relays are configured in two parallel banks or paths. Each of the two train control processors controls two of the solid-state relays, one in each bank.

Two of the solid-state relays must be “open” (one in each leg) in order to apply the brakes. The solid-state relays are held “closed” by receiving the AC signal from a driver in each of the two train control processors as well as by receiving a third and fourth AC signal from a third driver. The receipt of any DC signal, or a component failure in the brake interface unit, causes the solid-state relays to “open”. Current flow in each of the penalty brake circuit legs are monitored by current sensors (e.g., Hall Effect sensors, etc.), which are inductively isolated from the penalty brake circuit.

At some periodic rate, each of the four solid-state relays are tested without applying the brakes. Current sensors in both paths inform the processors as to the status of the relays in each path.

Advantages of the illustrative embodiment include, among others:
passive circuit design such that no power supplies are required;
fail-safe design to ensure safety;
two independent means to activate braking; and
self tests periodically verify circuit operations to provide continuous monitoring of redundant braking and test signals without brake application.

### BRIEF DESCRIPTION OF THE DRAWINGS

FIG. 1 depicts a train control system including a brake interface unit in accordance with the illustrative embodiment of the present invention.

FIG. 2 depicts a schematic diagram of the salient components of brake interface unit (BIU) 130.

FIG. 3 depicts a schematic diagram of the salient components of vital positive train control (V-PTC) 110.

FIG. 4 depicts a schematic diagram of the salient components of failure detection processor 220.

FIG. 5 depicts a schematic diagram of the salient components of brake application circuitry (BAC) 230.

FIG. 6A depicts a schematic diagram of the salient logic components of the train control system of FIG. 1.

FIG. 6B depicts a schematic diagram of the salient hardware components of the train control system of FIG. 1.

FIG. 7 depicts a schematic diagram of an exemplary relay.

FIG. 8 depicts a schematic of brake interface circuit (BIC) 510-i.

FIG. 9 depicts a schematic diagram of a circuit that is used in the illustrative embodiment of the present invention to filter the output of sensors 514 and 523.

FIG. 10 depicts a flowchart of the execution of the salient tasks that are performed by failure detection processor 220.

FIG. 11 depicts a flowchart of the execution of the salient sub-tasks associated with detecting a failure in brake interface unit (BIU) 130.

FIG. 12 depicts a flowchart of the execution of the salient sub-tasks associated with detecting a failure in brake interface unit (BIU) 130 as performed by another illustrative embodiment of the present invention.

FIG. 13 depicts a flowchart of the execution of the salient sub-tasks associated with a first diagnostic routine that is performed by failure detection application 440.

FIG. 14 depicts a flowchart of the execution of the salient sub-tasks associated with a second diagnostic routine that is performed by failure detection application 440.

FIG. 15 depicts a flowchart of the execution of the salient sub-tasks associated with a third diagnostic routine that is performed by failure detection application 440.

FIG. 16 depicts a flowchart of the execution of the salient sub-tasks associated with task 1040.

### DETAILED DESCRIPTION

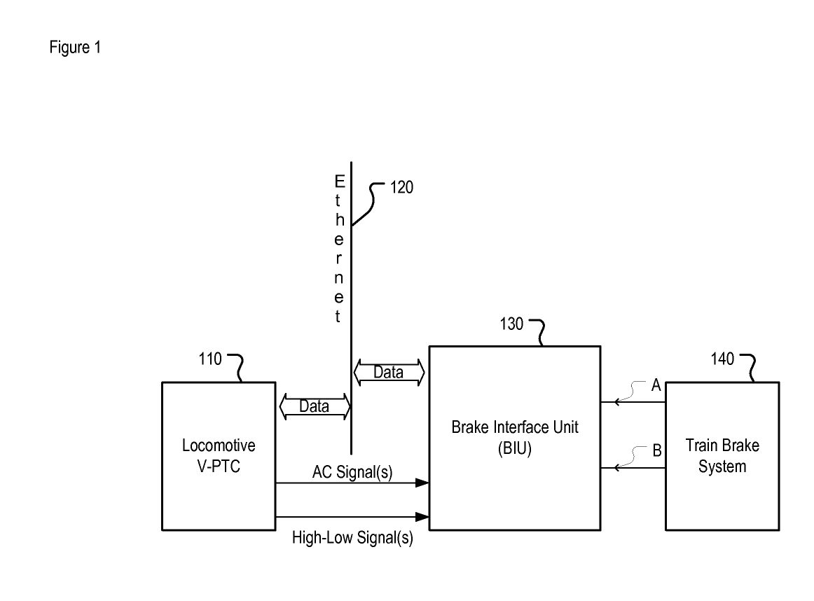

FIG. 1 depicts a train control system including a brake interface unit in accordance with the illustrative embodiment of the present invention. The train control system comprises, vital positive train control (V-PTC) 110, brake interface unit (BIU) 130, and train brake system 140.

Brake interface unit (BIU) 130 is interface for engaging the brakes on a train. It is connected to at least one train control processor that is in control of a train's braking. In accordance with the illustrative embodiment of the present invention, brake interface unit (BIU) 130 performs one or more of the following six (6) functions:

(1) carry instructions of a train control processor to apply the brakes on a train;

(2) detect a failure in the train control processor;

(3) detect a failure in its own circuitry;

(4) apply the brakes when a failure is found;

(5) perform self diagnostics; and

(6) perform any other action that is specified in the remainder of this disclosure.

Specifically, brake interface unit (BIU) 130 is designed to maintain a short between the two wires—wire A and wire B—that connect it to train braking system 140. The wires connect to a train's electronic braking system or MagValve, depending on the design of the locomotive on which the present invention is used. When a short between wire A and wire B is maintained, the train brakes are in the “released” state. When the short is lost, the brakes are applied. For the purposes of this disclosure, when the brakes of train brake system 140 are applied, the braking system is said to be “engaged” or in “an engaged state.”

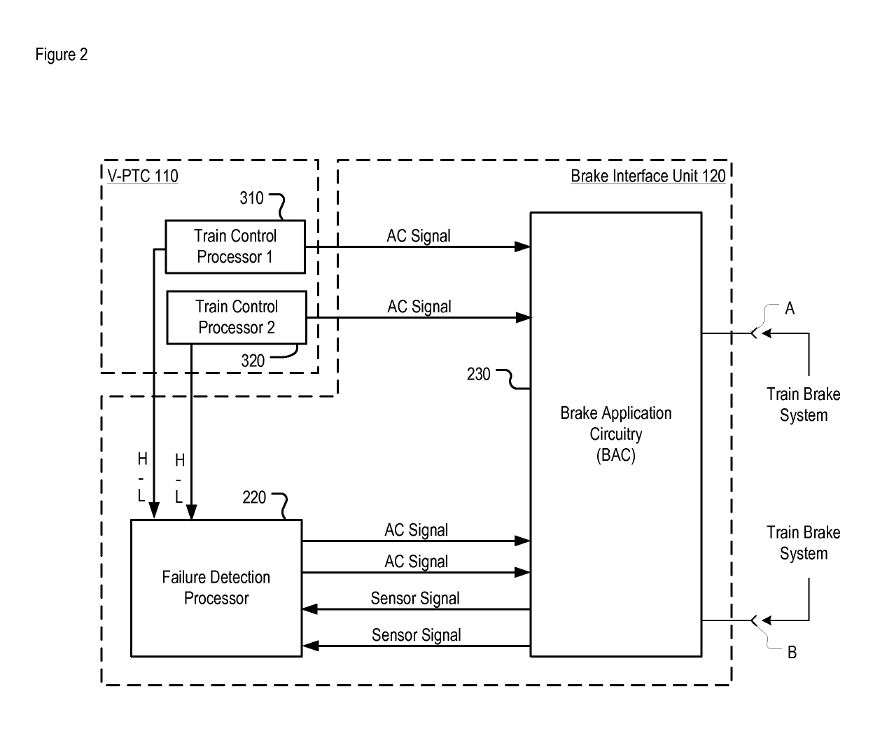

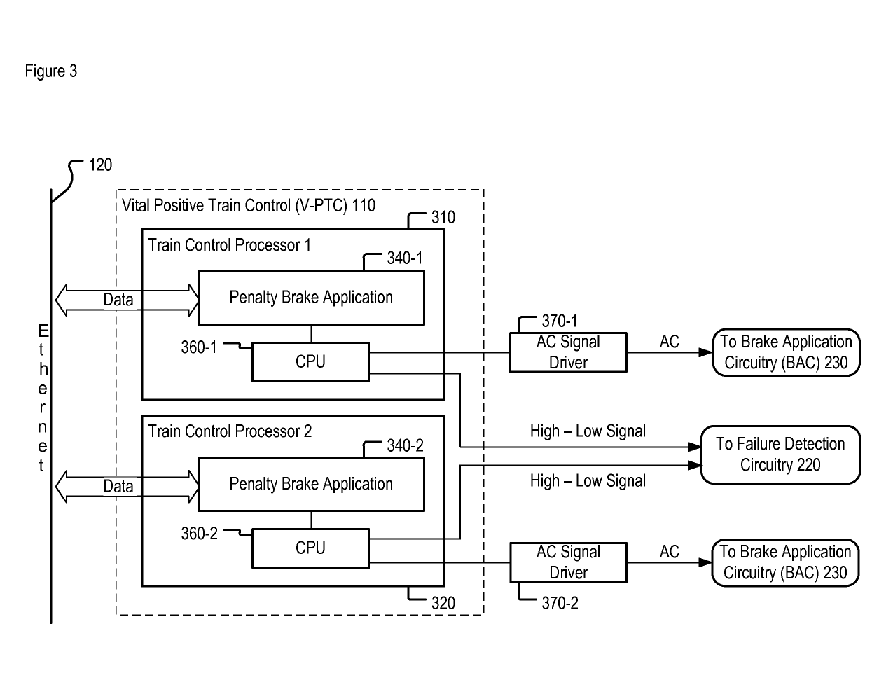

Vital positive train control (V-PTC) 110 is a system for monitoring and controlling train movements. It is equipment that is carried on board of trains which enforces speed limits, automatically applies brakes, and performs other functions. In accordance with the illustrative embodiment of the present invention vital positive train control (V-PTC) 110 comprises two processors: train control processor 310 and train control processor 320 (See, e.g., FIG. 2-3, etc.). Each processor executes logic for determining when the penalty braking on a train should be applied. The logic is denoted penalty brake application 340-1 and 340-2. (See, e.g., FIG. 3, etc.). The logic of the penalty brake applications determines what signals are provided to brake interface unit (BIU) 130 and when. It depends on these signals whether brake interface unit (BIU) 130 applies the brakes of train brake system 140.

Two types of signals are used by vital positive train control (V-PTC) to manipulate the operation of brake interface unit (BIU) 130: AC signals and High-Low signals. The AC signals energize switching devices (e.g., relays, etc.) that are used to maintain the short between wire A and wire B. The High-Low signals cause brake interface unit (BIU) 130 to generate additional AC signals. The additional AC signals also energize switching devices (e.g., relays, etc.) that are used to maintain the short between wire A and wire B.

In addition to the AC and High-Low signals, vital positive train control (V-PTC) 110 is capable exchanging data with brake interface unit (BIU) 130 via network 120. Network 120 is an Ethernet network. However, it will be clear to those skilled in the art, after reading this disclosure, how to make and use alternative embodiments of the present invention in which the data communication between the train control processors is implemented in alternative means (e.g., universal serial bus, controller area network (CAN-bus), etc.).

The capability to receive and send data to vital positive train control (V-PTC) 110 further increases the functionality of the present invention. Nevertheless, it should be noted that network 120 is dispensable. Those skilled in the art will readily recognize, after reading this disclosure, that alternative embodiments of the present invention can be devised in which vital positive train control (V-PTC) and brake interface unit (BIU) 130 exchange the AC signals only.

In accordance with the illustrative embodiment of the present invention, vital positive train control (V-PTC) generates two AC signals. However, those skilled in the art will readily recognize, after reading this disclosure, that any number of AC signals can be used by vital positive train control (V-PTC) 110 to manipulate the operation of brake interface unit (BIU) 130 (e.g., 1, 3, 5, 10, etc.).

Furthermore, in accordance with the illustrative embodiment, brake interface unit (BIU) 130 is an interface for the engaging of the penalty brakes of a train. However, it will be clear to those skilled in the art, after reading this disclosure, how to make and use alternative embodiment of the present invention in which brake interface unit (BIU) 130 is an interface between the brake a system of a train and any part of a train control system (e.g., positive train separation system, etc.).

FIG. 2 depicts a schematic diagram of the salient components of brake interface unit (BIU) 130. Brake interface unit (BIU) 130 comprises brake application circuitry (BAC) 230 and failure detection processor 220.

Brake application circuitry (BAC) 220 is circuitry comprising at least one switching device and at least one sensor that is capable of providing information about a state of the at least one of the switching device(s). In the illustrative embodiment, brake interface unit 220 comprises four relays, four relay drivers, and two current flow sensors. The relays are used to maintain and/or interrupt the short between wire A and wire B. When wire A is disconnected from wire B, the brakes of train brake system 140 become applied.

The switching devices in brake application circuitry (BAC) 230 are energized by signals (i.e., the AC signals, etc.) provided by both vital positive train control (V-PTC) 110 and failure detection processor 220. However, it will be clear to those skilled in the art, after reading this disclosure, how to make and use alternative embodiment of the present invention, in which only one of vital positive train control (V-PTC) 110 and failure detection processor 220 provides the signal(s) that energize the switching devices inside brake application circuitry (BAC).

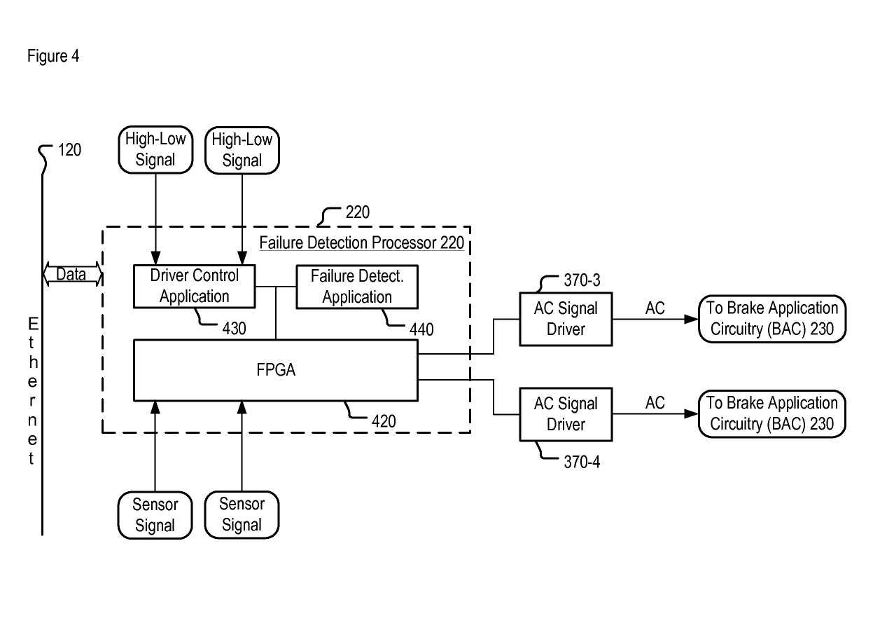

In addition to generating AC signals, vital positive train control (V-PTC) 110 provides High-Low signals to failure detection processor 220. The manner in which the High-Low signals are used is further described in the discussion with respect to FIG. 4.

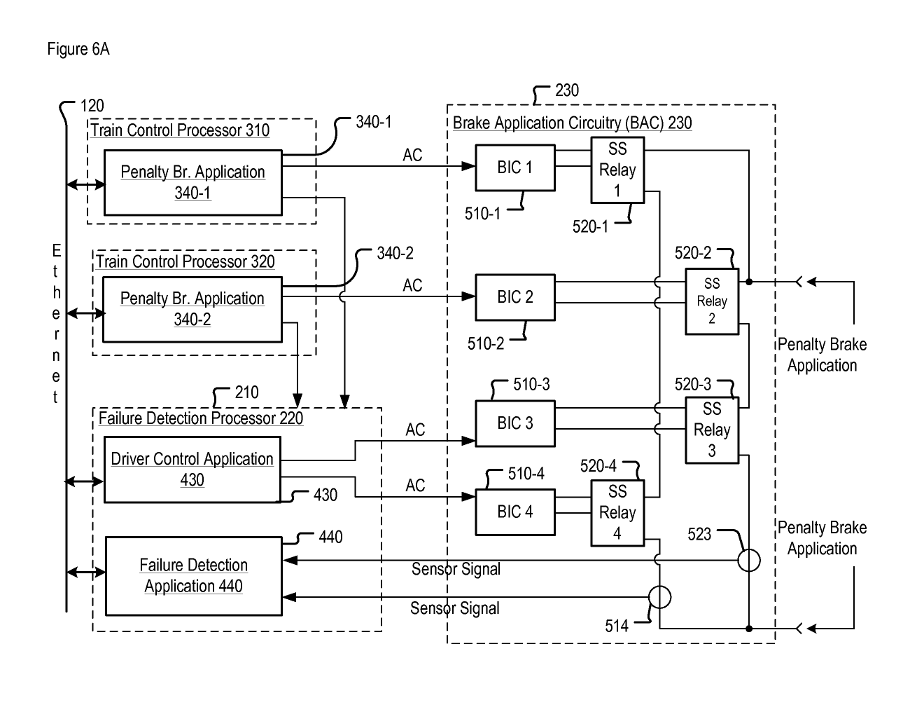

Failure detection processor 220 comprises circuitry and logic for detecting failures in at least one of brake application circuitry (BAC) 230, train control processor 310, and train control processor 320. Failure detection processor 220 detects failures on the basis of feedback from at least one sensor that forms part of brake application circuitry (BAC) 230 and/or the High-Low signals that are provided by the train control processors. Details about the structure and operation of failure detection processor 220 are provided in the discussion with respect to FIG. 4 and FIG. 6B.

FIG. 3 depicts a schematic diagram of the salient components of vital positive train control (V-PTC) 110. Vital positive train control (V-PTC) 110 comprises train control processor 310 and train control processor 320.

Train control processor 310 is hardware and software capable of controlling the operation of a train. Specifically, it comprises hardware and software for operating the penalty braking system of a train. In the illustrative embodiment of the present invention, train control processor 310 produces one (1) AC signal and one (1) High-Low signal. The AC signal is fed to brake application circuitry (BAC) 230 and the High-Low signal is fed to failure detection processor 220.

Train control processor 310 operates driver 370-1. Driver 370-1 is circuitry for the generation of the AC signal. Driver 370-1 contains dual circuits, only one of which is used. In the illustrative embodiment of the present invention, driver 370-1 is a Dual High Speed Low-Side Power MOSFET Driver which produces a 9.6 KHz, 5V AC current. Driver 370-1 is capable of producing and removing the AC signal in response to the receipt of signals from CPU 360-1.

In accordance with the illustrative embodiment of the present invention, driver 370-1 is a serial port. However, it will be clear to those skilled in the art, after reading this disclosure, how to make and use alternative embodiments of the present invention in which driver 370-1 is any other circuitry that is capable of generating a signal on behalf of train control processor 310 (e.g, another type of port, a custom circuit for producing AC or other signals, etc.).

Train control processor 310 comprises CPU 360-1 and penalty brake application 340-1. CPU 360-1 is a central processing unit that executes penalty brake application 340-1. In addition, CPU 360-1 controls the operation of driver 370-1. It is capable of causing driver 370-1 to generate an AC signal as well as remove an AC signal that is being generated. In accordance with the illustrative embodiment of the present invention, the central processing unit (CPU) is 600 MHz, ROM-less unit.

Penalty brake application 340-1 is software for applying the penalty brakes on a train. It is capable of determining when a train is operated or about to be operated in an unsafe manner and correspondingly applying the brakes of the train. It applies the brakes by removing the AC signal that is produced by driver 370-1, as well as setting the High-Low signal that is sent to failure detection processor 220 to Low. The Low signal causes failure detection processor 220 to remove the AC signal generated by driver 370-3. Penalty brake application 340-1 is executed by CPU 360-1.

In accordance with the illustrative embodiment of the present invention, the High-Low signal is output by an I/O pin on CPU 360-1. However, it will be clear to those skilled in the art, after reading this disclosure, how to make and use alternative embodiments of the present invention in which the High-Low Signal is produced a peripheral device or additional circuitry that is in communication with CPU 360-1.

Train control processor 320 is hardware and software which, together with train control processor 310, in a redundant fashion, controls the operation of a train. Train control processor 320 comprises hardware and software for operating the penalty braking system of a train. In the illustrative embodiment, train control processor 320 produces one (1) AC signal and one (1) high-low signal. The AC signal is fed to brake application circuitry (BAC) 230 and the high-low signal is fed to failure detection processor 220.

Train control processor 320 operates driver 370-2. Driver 370-2 is circuitry for the generation of the AC signal. Driver 370-2 is identical to driver 370-1.

In accordance with the illustrative embodiment of the present invention, driver 370-2 is a serial port. However, it will be clear to those skilled in the art, after reading this disclosure, how to make and use alternative embodiments of the present invention in which driver 370-2 is any other circuitry that is capable of generating a signal on behalf of train control processor 320 (e.g, another type of port, a custom circuit for producing AC streams or other signals, etc.).

Train control processor 320 also comprises CPU 360-2. CPU 360-2 is a central processing unit that executes penalty brake application 340-2. In addition, CPU 360-2 controls the operation of driver 370-2. It is capable of causing driver 370-2 to generate an AC signal as well as remove an AC signal that is being generated. CPU 360-2 is identical to CPU 360-1.

Penalty brake application 340-2 is software for applying the penalty brakes on a train. It is capable of determining when a train is operated or about to be operated in an unsafe manner and correspondingly applying the train's penalty brakes. It applies the penalty brakes by removing the AC signal that is produced by driver 370-2, as well as setting the High-Low signal that is sent to failure detection processor 220 to Low. The Low signal causes failure detection processor 220 to remove the AC signal generated by driver 370-4. Penalty brake application 340-2 is executed by CPU 360-2.

In accordance with the illustrative embodiment of the present invention, the High-Low signal is output by an I/O pin on CPU 360-2 itself. However, it will be clear to those skilled in the art, after reading this disclosure, how to make and use alternative embodiments of the present invention in which the High-Low Signal is produced a peripheral device or additional circuitry that is in communication with CPU 360-2.

Although not depicted in FIG. 3, train control processor 310 and/or train control processor 320 comprise additional hardware such as memory, input and output ports. It will be clear to those skilled in the art how to make and use embodiments of the present invention in which train control processor 310 and/or train control processor 320 comprise additional hardware elements that are necessary for the performance of their functions (e.g., I/O ports, memory, etc.).

The functions of the train control processors are not limited to running the penalty brake system of a train. In the illustrative embodiment of the present invention, train control processor 310 and train control processor 320, operate in a redundant fashion all systems that comprise vital positive train control (V-PTC) 110. Examples of such systems include movement planning systems, positive train separation systems, etc. For the purposes of clarity, however, this disclosure focuses on the operation of vital positive train control (V-PTC) 110 of the penalty brake system of a train.

FIG. 4 depicts a schematic diagram of the salient components of failure detection processor 220. Failure detection processor 220 comprises FPGA 420, driver control application 430, and failure detection application 440.

Failure detection processor 220 performs two salient functions:
(A) it applies the brakes of train brake system 140 when it detects a failure; and
(B) it detects failures in brake interface unit (BIU) 130, train control processor 310, and train control processor 320.

In relation to the detection of failures, failure detection processor 220 receives four (4) signals—two (2) High-Low signals from application processors 310 and 320, respectively; and two (2) sensor signals. The High-Low signals, among other uses, are used in detecting failures in application control processors 310 and 320. The sensor signals provide information about state(s) of components of brake application circuitry (BAC) 230. The manner in which failure detection is performed is further described in the discussions with respect to FIG. 11.

Failure detection processor 220 is implemented with a field programmable gate array (FPGA) processor—FPGA 420. The FPGA is configured to execute penalty driver control application 430 and failure detection application 440. Although not depicted in FIG. 4, failure detection processor 220 comprises additional hardware such as memory, input and output ports. It will be clear to those skilled in the art, after reading this disclosure, how to make and use embodiments of the present invention in which failure detection processor 220 includes additional hardware elements that are necessary for the performance of the functions of driver control application 430 and failure detection application 440 (e.g., I/O ports, memory, etc.).

Driver control application 430 is logic for applying the brakes of train brake system 140. Driver control application is programmed directly onto FPGA 420. Driver control application 430 is applies the brakes of train brake system 140 in response to signal from: (i) positive train control (V-PTC) 110 or (ii) failure detection application 440 or (iii) both i and ii. Driver control application 430 applies the brakes of train brake system 140 by setting drivers 370-3 and 370-4 to stop generating AC signals. When the AC signals produced by the two drivers are removed, the short between wire A and wire B is interrupted and the brakes of train brake system 140 are applied.

The use of a High-Low signals allows train control processors 310 and 320 to add diversity to the manner in which they operate the relays of brake application circuitry (BAC) 230. As noted, driver 370-1 and 370-2 are serial ports on the boards used by train control processor 310 and train control processor 320. In the event of a failure of the serial ports, (e.g., problems with the software drivers for the ports, etc.), the train processors can use the High-Low signals to open the relays of brake application circuitry (BAC) 230 and interrupt the short between wire A and wire B which connect brake interface unit (BIU) 130 to train control system 140. When short is interrupted, the brakes of train brake system 140 are applied.

Driver control application 430 operates drivers 370-3 and 370-4. Both drivers are identical to driver 370-1. They are capable of producing (and removing) AC signals in response to the receipt of signals from driver control application 430.

In accordance with the illustrative embodiment of the present invention, drivers 370-3 and 370-4 are programmable pins on FPGA 420. However, it will be clear to those skilled in the art, after reading this disclosure, how to make and use alternative embodiments of the present invention in which drivers 370-3 and 370-4 are any other circuitry that is capable of generating a signals on behalf of failure detection processor 220.

The High-Low signals fed into failure detection processor 220 determine whether drivers 370-3 and 370-4 are set to output AC signals. Driver control application 430 outputs an AC signal from driver 370-3 when it is fed a High signal from train control processor 310. When it receives a Low signal from train control processor 310, driver control application 430 removes the AC signal that is output by driver 370-3. Similarly, driver control application 430 outputs an AC signal from driver 370-4 when it is fed a High signal from train control processor 320. When it receives a Low signal from train control processor 320, driver control application removes the AC signal that is output by driver 370-4.

Additionally, driver control application 430 is capable of receiving and executing instructions (or signals) from failure detection application 440 to engage the brakes of train brake system 140. When such instructions are received, driver control application 430 removes the AC signals that are output by drivers 370-3 and 370-4.

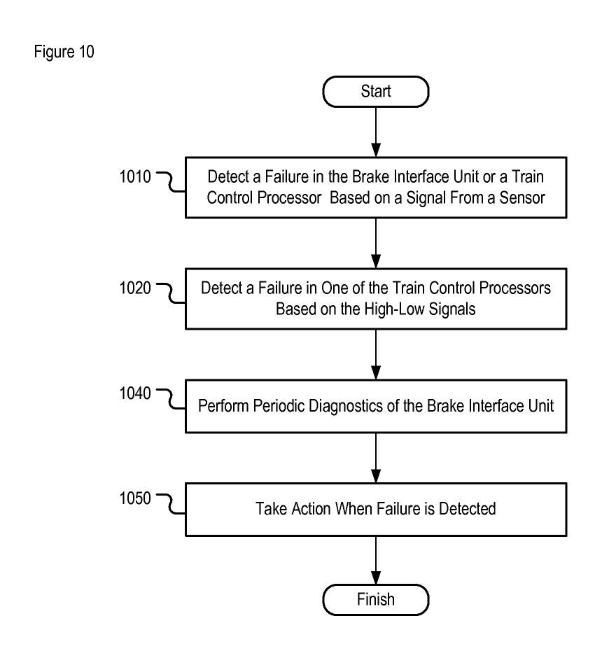

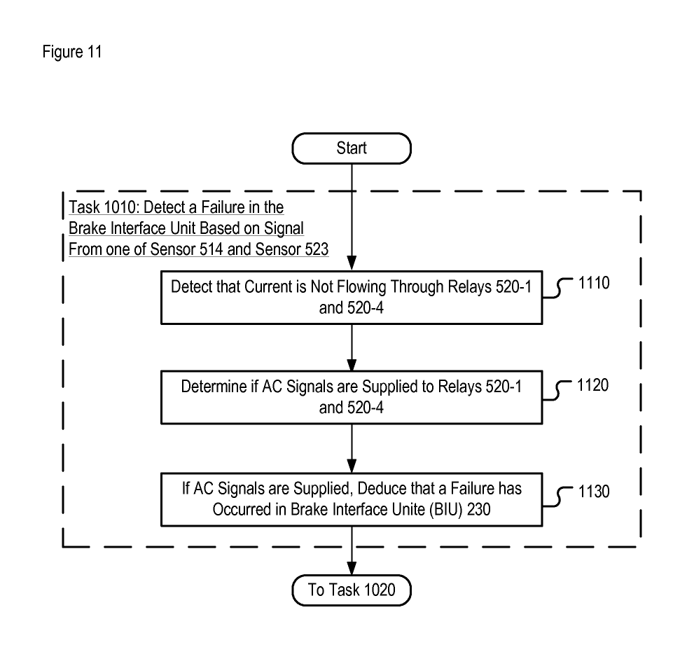

Failure detection application 440 is logic for detecting failures. In the illustrative embodiment of the present invention, failure detection application 440 is programmed directly onto FPGA 420. The tasks performed by failure detection application 440 are further described in the discussion with respect to FIGS. 10-13.

Although, in accordance with the illustrative embodiment of the present invention, failure detection application 440 is executed by failure detector 220, it will be clear to those skilled in the art, after reading this disclosure, how to make and use alternative embodiments of the present invention in which failure detection application 440 is executed by at least one of train control processor 310 and train control processor 320. In the alternative embodiments, at least one sensor signal from brake application circuitry (BAC) 230 is fed into the train control processor(s) that executes failure detection application 440. The sensor signal is used by failure detection application 440 in detecting failures.

Furthermore, in accordance with the illustrative embodiment of the present invention, driver control application 430 and failure detection application 440 are programmed directly onto FPGA 420. However, it will be clear to those skilled in the art, after reading this disclosure, how to make and use alternative embodiments of the present invention in which the applications are implemented in software and executed by a general purpose CPU.

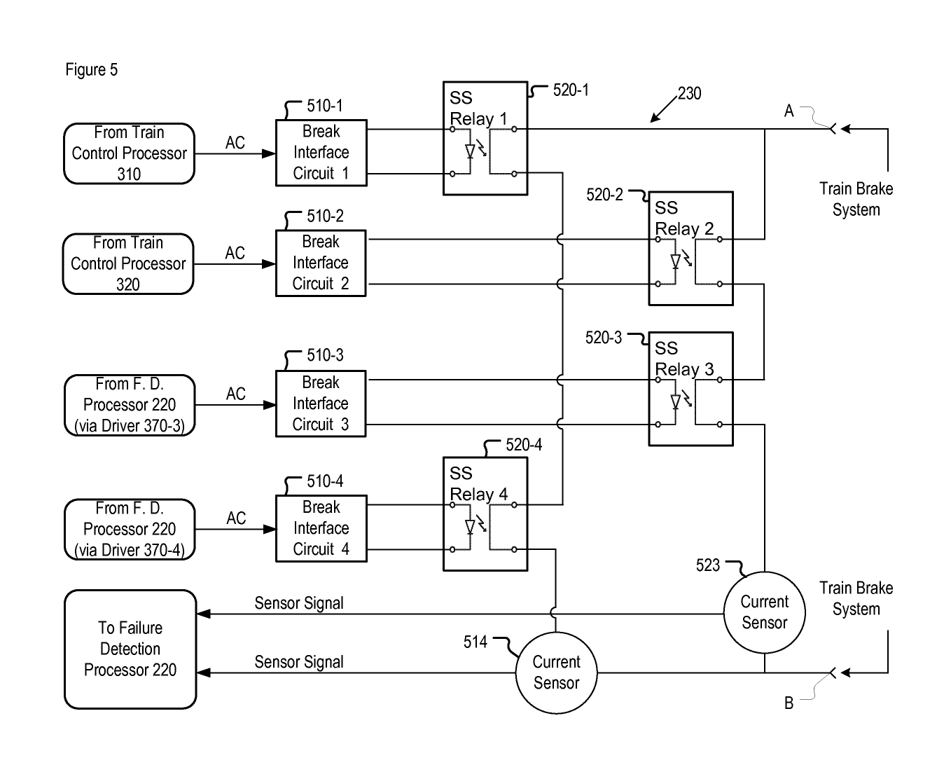

FIG. 5 depicts a schematic diagram of the salient components of brake application circuitry (BAC) 230. Brake unit comprises brake interface circuit (BIC) 510-i, relay 520-i, sensor 514, and sensor 523, where i ε {1, 2, 3, 4}.

Brake application circuitry (BAC) 230 is circuitry for applying the brakes of train brake system 140. When the wires that connect application circuitry (BAC) 230 to train brake system 140 are shorted, the brakes of train brake system 140 are in the “released” state. When the short between the wires is removed, the brakes of train brake system 140 are in the “applied” state.

As shown, brake application circuitry (BAC) 230 comprises two circuit legs. The first leg consists of relay 520-1 and 520-4 and the other leg consists of relay 520-2 and 520-3. Sensor 514 measures current flow across the first circuit leg, and sensor 523 measures the current flow across the second circuit leg. When the first circuit leg is closed, sensor 514 transmits sensor signal to failure detection processor 220 indicating that current is flowing through it. Similarly, when the first leg is closed, sensor 523 transmits sensor signal to failure detection processor 220 indicating that current is flowing through it. Failure detection processor 220 uses the signals from the sensors for testing purposes.

In normal operation, when all relays are energized, both legs will have current flowing and this current flow is an indication that the brake interface is operational. Periodically, during normal operation, application processors 310 and 320 and failure detection processor 220 stop generating their AC signals; only 1 signal at a time is stopped. This will cause its respective relay to open. The appropriate current sensor (sensor 514 or 523) will then indicate the absence of current flow. In this manner, the operation of each of the four solid state relays can be checked. Since only one relay at a time is open, the other circuit leg will maintain the short that is needed to prevent application of the brakes. As a consequence, this method of testing can be performed during normal operation without actually applying the train brakes.

Brake interface circuit (BIC) 510-i is a driver for relay 520-i. Brake interface circuit 510-i receives AC signal as input and converts it to a DC signal. The DC signal is used to drive relays 520-i.

FIG. 8 depicts a schematic of brake interface circuit (BIC) 510-i. The input from the Driver is an AC signal. Diodes D1 and D2 rectify this signal to DC which is then filtered by C2, R3 and R4. This smoothed DC then drives the LED in relays 520-i which, in turn, causes photovoltaic diodes in relays 520-i to generate a voltage sufficient to turn on power MOSFETs in relays 520-i which causes the relays to conduct.

It is notable that the AC signal must be continuously present to keep relays 520-i energized. Capacitor C2 will discharge in a few milliseconds if the AC input ceases. R1 is an input load resistor and C1 provides AC coupling. If the AC input is lost or becomes DC, no output will be produced and the relay will become de-energized. The appropriate current sensor will detect this fault and any other fault, causing a relay to become de-energized.

In the illustrative embodiment, the AC signal received by the brake interface circuits (BIC) 510-i from drivers 370-i is 5 volts, 9.6 kHz/50%, and:

R1: 10 kohm, 1/16 watt, 1%;

R2: 10 ohms, 1 watt, 5%;

R3: 1 kohm, ⅛ watt, 1%;

R4: 27 ohms, ¼ watt, 1%;

C1: 4.7 μfarads, 16 volts, ceramic, 20%;

C2: 47 μfarads, 25 volts, ceramic, 20%;

D1 and D2: BAT54 (Schottky barrier diodes), 20V, 300 mwatt.

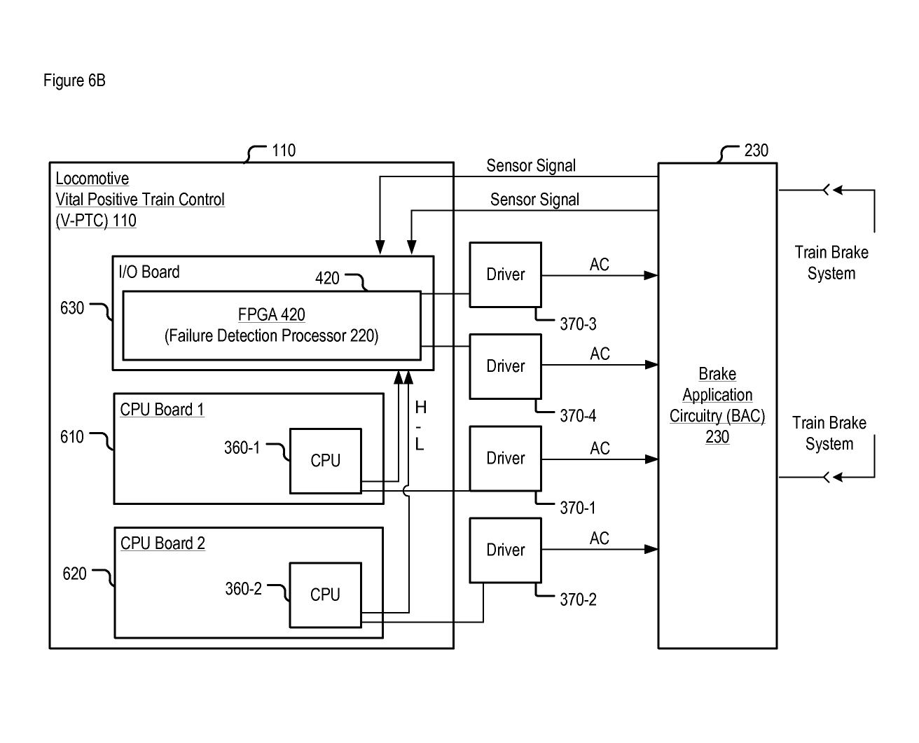

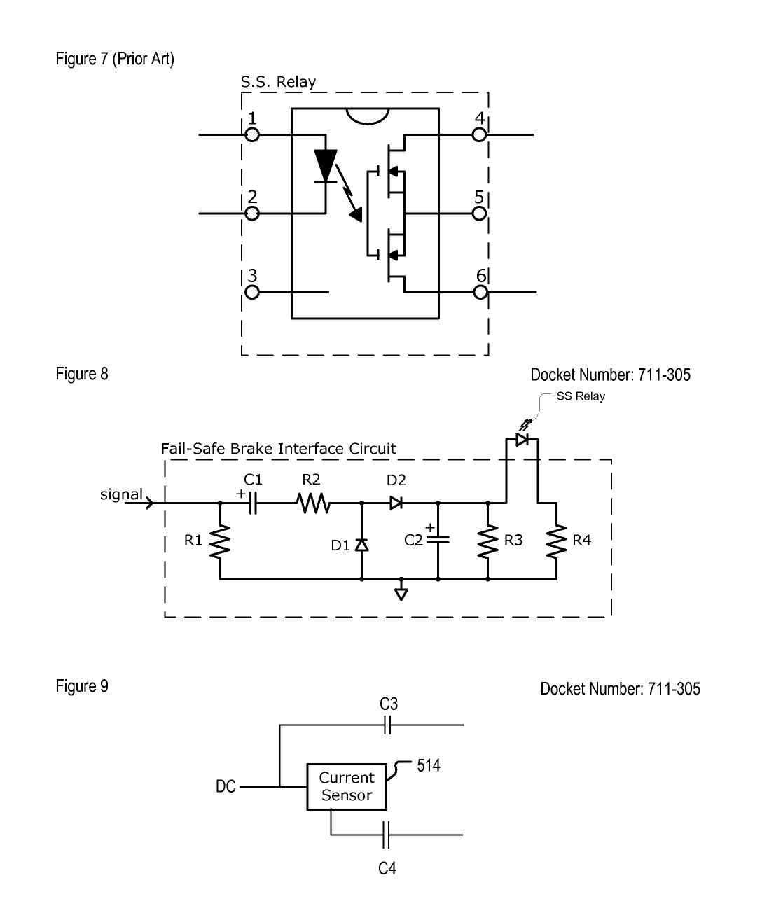

Relay 520-i is a solid state relay. In accordance with the illustrative embodiment of the present invention, relay 520-i is a MOSFET N/O SPST Photovoltaic AC-DC Relay. FIG. 7 depicts a schematic diagram of a relay from the type that is used in the illustrative embodiment of the present invention. As shown, the relay comprises a light emitting diode (LED) which when energized turns on power MOSFETs in the relay which causes the relay to conduct.

In the illustrative embodiment of the present invention, solid state relays are used to close short the wires that connect brake interface unit (BIU) 130 to train brake system 140. However, it will be clear to those skilled in the art, after reading this disclosure, how to make and use alternative embodiments of the present invention in which other switching devices are used (e.g., magnetic relays, transistors, etc.).

Although, in the illustrative embodiment of the present invention four (4) relays are used, it will be clear to those skilled in the art, after reading this disclosure, how to make and use alternative embodiments of the present invention in which brake application circuitry (BAC) 230 comprises any number of relays (e.g., 1, 5, 7, 10, 16, etc.). Furthermore, it will be clear to those skilled in the art, after reading this disclosure, how to make and use alternative embodiments of the present invention in which the relays are connected in a non-redundant fashion.

Sensor 514 is a Hall Effect-based linear current sensor. Sensor 514 detects current flowing across relays 520-1 and 520-4 and generates sensor signal that is proportional to the current flowing. Sensor 514 is inductively isolated from the other components of brake application circuitry (BAC) 230.

In the illustrative embodiment of the present invention, the feedback from sensor 514 is sent to failure detection processor 220 which uses it for testing purposes. In the alternative embodiments of the present invention where failure detection application 400 is executing on one of the train control processors, the signal from sensor 514 is sent to the train control processor which executes failure detection application 400.

Sensor 514 uses the circuit shown in FIG. 9. Capacitor C3 of that circuit acts as a noise filter for the DC power to the sensor while capacitor C4 is part of an internally connected RC filter that reduces noise on the sensor output.

In the illustrative embodiment, the specifications of capacitors C1 and C2 are, and:

C3: 0.1 μfarads, ceramic, 25 volts, X7R 0603;

C4: 0.1 μfarads, ceramic, 25 volts, X7R 0603;

Sensor 523 is a Hall Effect-based linear current sensor. Sensor 523 detects current flowing across relays 520-2 and 520-3 and generates sensor signal that is proportional to the current flowing. Sensor 523 is inductively isolated from the other components of brake application circuitry (BAC) 230. The feedback from sensor 523 is sent to failure detection processor 220 which uses it for test purposes. Sensor 523 also uses the circuit depicted in FIG. 9.

In the illustrative embodiment of the present invention, the feedback from sensor 514 is sent to failure detection processor 220 which uses it for testing purposes. In the alternative embodiments of the present invention where failure detection application 400 is executing on one of the train control processors, the signal from sensor 514 is sent to the train control processor which executes failure detection application 400.

Furthermore, in the illustrative embodiment, the current sense connection to each current sensor is a copper conductor which is inductively coupled to the rest of the sensor. As a consequence, loss of DC power to the current sensor does not affect the ability of the Brake Interface Unit to cause brake application.

Although, in the illustrative embodiment of the present invention, brake interface unit (BIU) 230 uses current sensors to provide information about its state to failure detection processor 220, it will be clear to those skilled in the art, after reading this disclosure, how to make and use alternative embodiments of the present invention in which other types of sensors are used (e.g., humidity sensors, temperature sensors, etc.).

Furthermore, although the illustrative embodiment of the present invention two (2) sensors are used, it will be clear to those skilled in the art after reading this disclosure, how to make and use alternative embodiments of the present invention in which any number of sensors is used (e.g., 1, 3, 10, 15, etc.). In these embodiments, the sensors can be configured to provide information about groups of components that comprise brake interface unit (BIU) 230 (as is the case in the illustrative embodiment), or the sensors can be configured to provide information about individual components.

FIG. 6A depicts a schematic diagram of the salient logic components of the train control system of FIG. 1.

Penalty brake application 340-1 of train control processor 310 is used to drive a first relay in brake application circuitry (BAC) 230, while penalty brake application 340-2 of train control processor 320 is used to drive a second relay. Driver control application 430 of failure detection processor 220 is used to drive a third and fourth relays. The three applications drive their respective relays by controlling the generation of electric signals that are used for energizing the relays (i.e., the AC signals in the illustrative embodiment, etc.).

The three applications are capable of applying the brakes of train brake system 140. The penalty braking applications apply the brakes of train brake system 140 by removing the signals that energize the relays in brake application circuitry (BAC) 230. Driver control application 430 applies the brakes of train brake system 140 by removing the AC signals that are generated by drivers 370-3 and 370-4.

Failure detection application 440 detects the presence of a failure in one of train control processor 310, train control processor 320, and brake interface unit (BIU) 130. It performs its failure-detecting functions on the basis of at least one sensor signal from brake application circuitry (BAC) 230 and/or the High-Low signals received from train control processor 310 and train control processor 320.

Brake application circuitry (BAC) 230 facilitates the operation of failure detection application 440 by feeding it at least one sensor signal. The at least one sensor signal is indicative of the state of at least one component of brake application circuitry (BAC) 230. The information contained in the sensor signal is used by the logic of failure detection application 440 to determine whether a component of penalty brake interface 130 has failed.

FIG. 6B depicts a schematic diagram of the salient hardware components of the train control system of FIG. 1.

Vital positive train control (V-PTC) 110 comprises CPU board 610 and CPU board 620, and I/O board 630. Each CPU board is computer hardware (e.g., processor, memory, network adapter, etc.) that controls the operation of a train. The two CPU boards are the computer hardware that constitutes train control processor 310 and train control processor 320. In the illustrative embodiment of the present invention, train control processor 310 is implemented on CPU board 610 and train control processor 320 is implemented on CPU board 620.

CPU 360-1 and CPU 360-2 are in electrical communication, via CPU board 610 and CPU board 620 with drivers 370-1 and 370-2. The two drivers comprise circuitry which is capable of generating an AC signal. The AC signal is used to energize one or more relays inside brake application circuitry (BAC) 230. CPUs 360-1 and 360-2 control the operation of drivers 370-1 and 370-2, respectively; they can cause the drivers to output or remove the AC signals which they are responsible for producing.

I/O board 630 is an expansion board which performs A/D conversion of signals that are input to vital positive train control (V-PTC) 110. Additionally, in the illustrative embodiment, I/O board 630 formats the signals that are input and forwards these signals to train control processor 310 and 320.

FPGA 420—which implements failure detection application 440—is mounted directly on the I/O board. FPGA 420, via I/O board 630, is in electrical communication with drivers 370-3 and 370-4. The two drivers comprise circuitry which is capable of generating an AC signal. The AC signal is used to energize one or more relays inside brake application circuitry (BAC) 230. FPGA 420 controls the operation of drivers 370-3 and 370-4; it can cause the drivers to output or remove the AC signals which they are responsible for producing. Although, in the illustrative embodiment of the present invention FPGA 420 is mounted on an I/O board, it will be clear to those skilled in the art, after reading this disclosure, how to make and use alternative embodiments of the present invention in which FPGA 420 is mounted on any board that forms part of the train control system (e.g., CPU board 610, CPU board 620, other peripheral boards, etc.).

Drivers 370-1, 370-2, 370-3, and 370-4 contain dual circuits, but only one of them is used. In accordance with the illustrative embodiment of the present invention drivers 370-1, 370-2 are ports on CPU Board 610, CPU Board 620, while drivers 370-3 and 340-4 are programmable pins on FPGA 420. However, it will be clear to those skilled in the art, after reading this disclosure, how to make and use alternative embodiments of the present invention in which the drivers are physically separate from CPU Board 610, CPU Board 620, and FPGA 420.

FIG. 10 depicts a flowchart of the execution of the salient tasks that are performed by failure detection processor 220. It will be clear to those skilled in the art, after reading this disclosure, how to perform the tasks associated with FIG. 10 in a different order than represented or to perform one or more of the tasks concurrently. Furthermore, it will be clear to those skilled in the art, after reading this disclosure, how to make and use alternative embodiments of the present invention that omit one or more of the tasks.

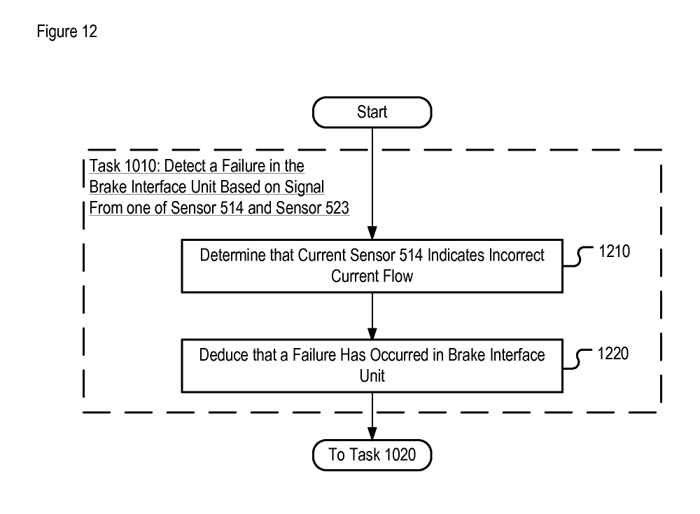

At task 1010, failure detection application 440 detects a failure in one of brake interface unit (BIU) 130, train control processor 310, and train control processor 320, based on a signal from a sensor that provides information about a state of a component of brake application circuitry (BAC) 230. Task 1011 is further described in the discussion with respect to FIG. 11 and FIG. 12.

At task 1020, failure detection application 440 detects a failure in one of train control processor 310 and train control processor 320. The failure is detected on the basis of the High-Low signals that are fed into failure detection processor 220 by the two train control processors. When the two signals are different (i.e., one is High and the other is Low, etc.) failure detection application 440 concludes that one of train control processor 310 and train control processor 320 has failed.

At task 1030, failure detection application 440 performs periodic diagnostics of penalty brake interface 130. Although, in the illustrative embodiment of the present invention, the diagnostics are performed periodically (e.g., every 1 second) it will be clear to those skilled in the art, after reading this disclosure, how to perform the diagnostics sporadically or just once.

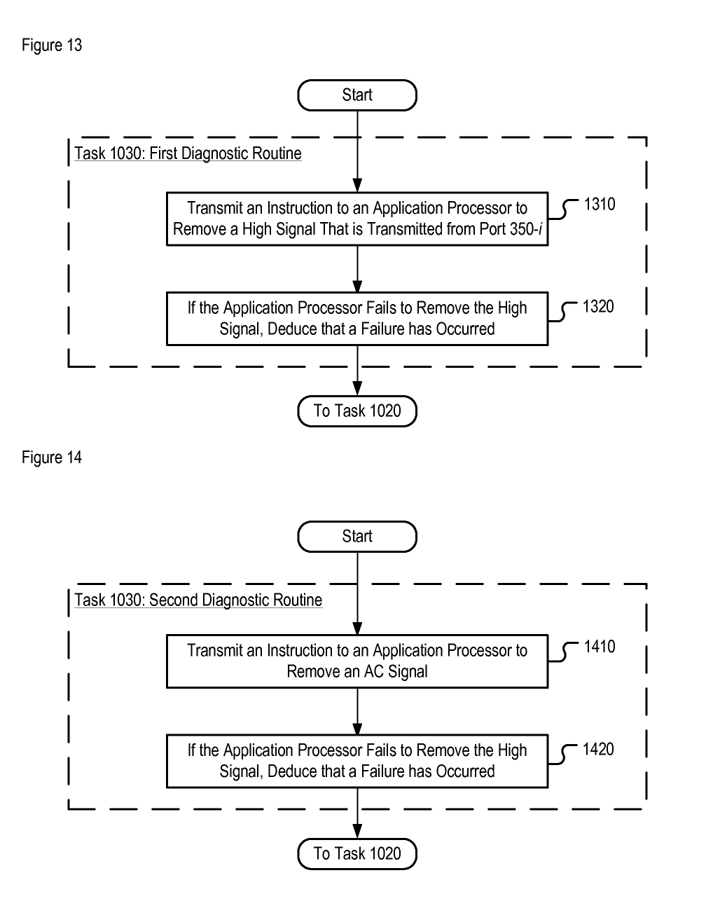

In accordance with the illustrative embodiment of the present invention, the diagnostics are preformed in real-time, without disturbing the normal operation of brake interface unit (BIU) 130. Furthermore, in accordance with the illustrative embodiment of the present invention, three types of diagnostics are performed. The three types of diagnostics are described in the discussion with respect to FIGS. 13-15.

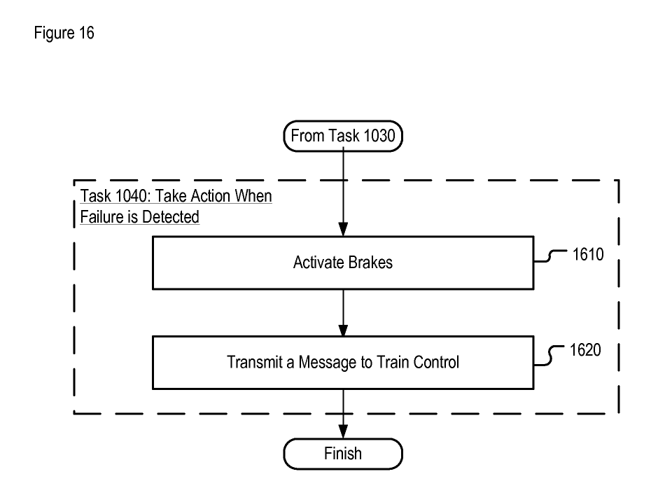

At task 1040, failure detection application 440 takes action when a failure is detected. Task 1040 is further described in the discussion with respect to FIG. 16.

FIG. 11 depicts a flowchart of the execution of the salient sub-tasks associated with detecting a failure in brake interface unit (BIU) 130.

At task 1110, failure detection application 440 determines that at least one of relays 520-1 and 520-4 is open. The determination is made on the basis of signal from current sensor 514. Although, in accordance with the illustrative embodiment of the present invention, relays 520-1 and 520-4 are monitored, it will be clear to those skilled in the art, after reading this disclosure, how to make and use alternative embodiments of the present invention in which relays 520-2 and 520-3 are monitored instead. The monitoring of relays 520-3 and 520-4 is performed in accordance with the methods described in relation to relays 520-1 and 520-4.

At task 1120, failure detection application 440 determines whether AC signals are supplied to relays 520-1 and relay 520-4. In accordance with the illustrative embodiment of the present invention, failure detection application 440 determines whether AC signal is supplied to relay 520-4 by communicating with driver control application 430.

Furthermore, failure detection application 440 determines whether AC signal is supplied to relay 520-1 by train control processor 310 on the basis of the High-Low signal which is fed to failure detection processor 220 by train control processor 310. If train control processor 310 feeds a High signal to failure detection processor 220, this is an indication that train control processor 310 is supplying AC signal to relay 520-1. Conversely, if a Low signal is received from train control processor 310, this is an indication that train control processor 310 has removed the AC signal for relay 520-1.

In alternative embodiments of the present invention in which failure detection application 440 is executing on one of train control processor 310, failure detection application 440 determines whether and AC signal is supplied to relay 520 by communicating with penalty brake application 340-1 or by monitoring the state of driver 370-1. Furthermore, in the alternative embodiments, failure detection application determines whether AC signal is supplied to relay 520-4 by monitoring whether a High-Low signal is output by CPU-360-1 to failure detection processor 220.

At task 1130, failure detection application 440 determines whether a failure has occurred. The determination is based on the information obtained in at least one of tasks 1110 and 1120. If AC signals are supplied to both relays 520-1 and 520-4, and yet, current is not flowing through current sensor 514, failure detection application 440 determines that at least one of brake interface unit (BIU) 130 and train control processor 310 has failed. Conversely, when one of relays 520-1 and 520-4 is not supplied with AC signal, and yet, current is flowing through it, failure detection application 440 also determines that at least one of brake interface unit (BIU) 130 and train control processor 310 has failed.

FIG. 12 depicts a flowchart of the execution of the salient sub-tasks associated with detecting a failure in brake interface unit (BIU) 130 or train control processor 310 as performed by another illustrative embodiment of the present invention.

At task 1210, failure detection application 440 determines that the current flow measured by one of current sensors 514 and 523 is incorrect. An incorrect current flow, is current flow is outside of predetermined bounds.

At task 1220, failure detection application 440 deduces that a failure has occurred in brake interface unit (BIU) 130 based on the information obtained at task 1210. In particular, when failure detection application 440 receives signal from one of sensors 514 and 523 that is outside of predetermined bounds, it determines that a failure has occurred.

FIG. 13 depicts a flowchart of the execution of the salient sub-tasks associated with a first diagnostic routine that is performed by failure detection application 440.

At task 1310, failure detection application 440 instructs train control processor 310 to remove to set the High-Low signal to Low. In accordance with the illustrative embodiment of the present invention, the instruction is submitted in the form of a message that is transmitted over network 120.

At task 1320, failure detection application 440 determines whether train control processor 310 has failed based on the response of train control 310 to the instruction transmitted at task 1310. If the high signal is not removed, despite the instruction, failure detection application 440 determines that train control processor 310 has failed and is non-responsive.

FIG. 14 depicts a flowchart of the execution of the salient sub-tasks associated with a second diagnostic routine that is performed by failure detection application 440.

At task 1410, failure detection application 440 removes one of the AC signals generated by train control processor 310 and train control processor 320. It should be noted that only one of the AC signals generated by train control processor 310 and 320 is removed. This allows brake interface unit (BIU) 130 to continue operating uninterrupted.

In accordance with the illustrative embodiment of the present invention, failure detection application 440 removes the AC signal that is generated by train control processor 310. It removes the signal by instructing train control processor 310 to remove the AC signal that is output from driver 370-1. The instruction is submitted in the form of a message that is transmitted over network 120.

In the alternative embodiments of the present invention in which failure detection application 440 is executed by train control processor 310, failure detection application 440 uses internal means of communication (e.g., inter-process communication techniques, etc.) to instruct penalty brake application 340-1 to remove the AC signal that is produced by AC driver 370-1.

At task 1420, failure detection module determines whether a failure has occurred based on the response of train control processor 310 to the instruction transmitted at task 1410. If the AC signal is not removed, failure detection module determines that train control processor 310 has failed. Whether the AC signal is removed is determined by using the signal from sensor 514. If sensor 514 indicates that current is flowing through it, that means that both relays 520-1 and 520-2 are energized which leads to the conclusion that either the AC signal is not removed (or relay 520-1 is stuck).

In accordance with the illustrative embodiment of the present invention, the train control processors remove their respective AC signals in response to instructions from train control application 440. However, it will be clear to those skilled in the art, after reading this disclosure, how to make and use alternative embodiments of the present invention in which train control processors 310 and 320 remove their AC signals automatically for the purposes of performing self-diagnostics. In these embodiments, only one AC signal at a time is turned off automatically by the train control processors.

In these embodiments, at task 1420, failure detection application 440 monitors the signal from sensors 514 and 523 to determine whether relays periodically become open in response to the turning off of the AC signals by train control processor 310 and train control processor 320.

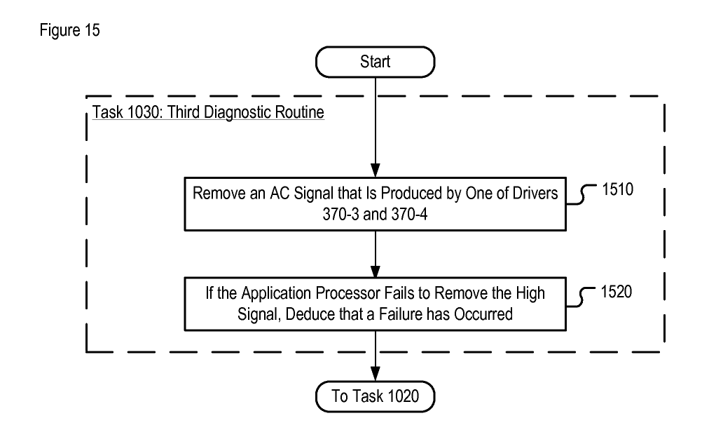

FIG. 15 depicts a flowchart of the execution of the salient sub-tasks associated with a third diagnostic routine that is performed by failure detection application 440.

At task 1510, failure detection application 440 instructs driver control application 430 to remove one of the AC signals that are output from drivers 370-3 and 370-4. It should be noted that only one of the AC signals generated by driver control application 430 is removed by failure detection application 440. This allows brake interface unit (BIU) 130 to continue operating uninterrupted.

In accordance with the illustrative embodiment of the present invention, failure detection application 440 instructs driver control application 430 to remove the AC signal that is produced by driver 370-4 by using inter-process communication techniques. In the alternative embodiments of the present invention in which failure detection application 440 is executed by train control processor 310, failure detection application 440 uses internal means of communication (e.g., interposes communication techniques, etc.) to instruct penalty brake application 340-1 to remove the High-Low signal that is fed to failure detection processor 220.

At task 1520, failure detection module determines whether a failure has occurred based on the signal from sensor 514. If sensor 514 continues to indicate that current is flowing though it after the AC signal is removed, failure detection application 440 determines that brake interface unit (BIU) 130 has failed.

FIG. 16 depicts a flowchart of the execution of the salient sub-tasks associated with task 1040. It will be clear to those skilled in the art, after reading this disclosure, how to perform the tasks associated with FIG. 16 in a different order than represented or to perform one or more of the tasks concurrently. Furthermore, it will be clear to those skilled in the art, after reading this disclosure, how to make and use alternative embodiments of the present invention that omit one or more of the tasks.

At task 1610, failure detection application 440 activates the brakes of train brake system 140. In accordance with the illustrative embodiment of the present invention, failure detection application 440 instructs driver control application 430 and/or penalty brake applications 340-1 and 340-2 to remove the AC signals produced by drivers 370-1 through 370-4. The removal of the AC signals results in the relays being de-energized which, in turn, results in the application of the train brakes.

At task 1620, failure detection application 440 transmits an indication to vital positive train control (V-PTC) 110 that a failure has occurred in penalty brake interface 130. In accordance with the illustrative embodiment of the present invention, the indication is transmitted over network 120.

It is to be understood that the types and parameters of the signals used by the present invention are provided for illustrative purposes only. It will be clear to those skilled in the art, after reading this disclosure, that a number of embodiments of the present invention can be devised in which the different signals are used to control brake application circuitry (BAC) 230.

Furthermore, it is to be understood that the parameters for the components of the present invention (e.g., CPUs, capacitors, resistors, etc.) are provided for illustrative purposes only. It will be clear to those skilled in the art, after reading this disclosure, that a number of embodiments of the present invention can be devised in which different components and/or components with different parameters are used.

In any event, it is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A train control system comprising a brake interface unit, wherein the brake interface unit is in electrical communication with a train control processor and a braking system, wherein the brake interface unit comprises circuitry that:
(a) is operable to detect failure in the train control processor;
(b) is self-diagnostic; and
(c) causes the braking system to engage when failure is detected in the train control processor or in the brake interface unit.

2. The train control system of claim 1 wherein the brake interface unit comprises a switching device and a sensor, wherein the sensor is operable to provide information about a state of the switching device to a processor which executes or comprises logic for the detection of failures.

3. The train control system of claim 2 wherein the sensor is a current flow sensor that measures the flow of current across the switching device thereby providing information whether the switching device is conducting.

4. The method of claim 2 wherein the processor is the train control processor.

5. The method of claim 2 wherein the processor is a processor that is mounted on a expansion board that is used by the train control processor.

6. The method of claim 1 wherein:
the brake interface unit comprises a first switching devise and a second switching device;
the first switching device is controlled by the train control processor; and
the second switching device is controlled by a processor mounted on an expansion board, wherein:
i. the processor mounted on the expansion board is in communication with the train control processor, and
ii. the processor mounted on the expansion board controls the second switching device in accordance with a signal that is received from the train control processor.

7. The train control system of claim 1 comprising:
a failure detection processor;
wherein the brake interface unit comprises a switching device and a sensor;
wherein the sensor is operable to provide information about the state of the switching device to the train control processor;
wherein the train control processor controls the state of the switching device; and
wherein the train control processor executes or comprises logic for the detection of failures.

8. The train control system of claim 1 comprising:
a failure detection processor that is communicatively coupled with the train control processor;
wherein the brake interface unit comprises a switching device and a sensor;
wherein the sensor is operable to provide information about the state of the switching device to the failure detection processor; and
wherein the train control processor is operable to change the state of the switching device in response to a signal from the failure detection processor.

9. A vital positive train control (V-PTC) system comprising a failure detection processor wherein:
i. the failure detection processor is operable to detect a failure in a brake interface unit,
ii. the brake interface unit is in electrical communication with a train control processor and a braking system,
iii. the brake interface unit is operable to engage the braking system;
iv. the brake interface unit comprises a first switching device and a sensor, and
v. the sensor is operable to provide feedback about a state of the first switching device to the failure detection processor.

10. The vital positive train control (V-PTC) system of claim 9 wherein:
the brake interface unit comprises a second switching device;
the first switching device is energized by a first signal and the second switching device is energized by a second signal, wherein the brake system is engaged when both of the first switching device and the second switching device are energized; and
the failure detection processor is operable to remove the first signal and determine whether a failure exists in the brake interface unit based on feedback that is received at the failure detection processor from the sensor following the removal of the first signal.

11. The vital positive train control (V-PTC) system of claim 9 wherein the failure detection processor is operable to periodically test one of the brake interface unit and a train control processor for failures without disturbing the operation of the brake interface unit.

12. A vital positive train control (V-PTC) system comprising a train control processor wherein:
i. the train control processor is operable to detect a failure in a brake interface unit,
ii. the brake interface unit is operable to engage the braking system;
iii. the brake interface unit comprises a first switching device and a sensor, and
iv. the sensor is operable to provide feedback about a state of the first switching device to the train control processor.

13. The vital positive train control (V-PTC) system of claim 12 wherein:
the brake interface unit comprises a second switching device;
the first switching device is energized by a first signal and the second switching device is energized by a second signal, wherein the brake system is engaged when both the first switching device and the second switching device are energized; and
the train control processor is operable to remove the first signal and determine whether a failure exists in the brake interface unit based on feedback that is received at the train control processor from the sensor following the removal of the first signal.

14. The vital positive train control (V-PTC) system of claim 12 wherein the train control processor is operable to periodically test one of the brake interface unit and a train control processor for failures without disturbing the operation of the brake interface unit.

15. A method comprising:
removing a first signal, wherein:
i. the first signal is used to energize a first switching device that is part of a brake interface unit that is in electrical communication with a train control processor and a braking system, and
ii. the brake interface unit is operable to engage the braking system;
receiving a signal from a first sensor, wherein the signal indicates a state of the first switching device;
when the switching device is an a first state, deducing that at least one of a train control processor and the brake switching device has failed.

16. The method of claim 15 wherein the removing, receiving, and deducing tasks are performed periodically.

17. The method of claim 15 wherein the brake interface unit has a redundant configuration, wherein the redundant configuration allows the brake interface unit to continue to operate properly after the first signal is removed.

18. The method of claim 15 wherein the first sensor is current sensor which indicates whether the switching device is conducting.
